(19) United States
(12) Patent Application Publication
(10) Pub. No.: US 2014/0257848 A1
(43) Pub. Date: Sep. 11, 2014

(54) Participant Account Identification and Location Updating System

(71) Applicant: GForce Ink, LLC, Rochester, MN (US)

(72) Inventor: GEOFF HEPPDING, Rushford, MN (US)

(73) Assignee: GFORCE INK, LLC, Rochester, MN (US)

(21) Appl. No.: 14/153,432

(22) Filed: Jan. 13, 2014

Related U.S. Application Data
(60) Provisional application No. 61/751,630, filed on Jan. 11, 2013.

(51) Int. Cl. G06Q 20/34; G06Q 50/24; G06Q 50/20

(52) U.S. Cl. CPC G06Q 20/3574; G06Q 50/20; G06Q 50/24
USPC 705/3

(57) ABSTRACT

A modular participant data management system is disclosed. The system includes a participant database accessible by a plurality of users, each of the plurality of users associated with at least one organization. The participant database includes participant data and event data, the participant data associating each of a plurality of participants with a unique code and a participant account associated with that unique code, the participant account including contact information, medical information, and funds information. The system includes a portal interface to the participant database, the portal interface providing access to authorized users of one or more student data management modules including a transit tracking module, a participant account module, and a medical data module

### CROSS-REFERENCE TO RELATED APPLICATION

This application claims the benefit of U.S. Patent Application Ser. No. 61/751,630 entitled “Participant Account Identification and Location Updating System,” filed Jan. 11, 2013, the entirety of which is hereby incorporated by reference.

### BACKGROUND

School districts or institutions (colleges, universities, etc.) often issue identification cards to users. Such identification cards can use magnetic stripe or bar codes to identify each student within the school district, and can be used to access a spending account managed by that institution. These systems have the advantage of avoiding circumstances where participants, such as students and in particular small children, are required to handle and manage money.

Concurrently, but entirely separately, systems exist in which a school district can communicate with a contracted bus company to determine a status of bus travel, including pick-up and drop-off of students. These systems generally include arrangements in which, either via usage of RFID or a bar code, a student's presence on/off a bus or in a classroom. These systems are used to ensure that students arrive at school safely, and can be used to ensure attendance in classes to provide feedback to parents and to ensure continued school funding, to the extent funding is based on attendance.

All of these types of systems have limitations and/or drawbacks. As an initial matter, these systems are costly, and require a large expenditure on behalf of the school districts or institutions that implement the systems. Furthermore, each system generally requires maintenance and therefore requires either continued maintenance by each district at which the systems are employed. Additionally, because these systems are managed entirely within each school district, they typically have generic access rights, but rather are limited as to the locations at which the data is accessible (e.g., data gathering limited to classrooms or buses, and data retrieval limited to a principal or superintendent). As such, these systems lack communication and feedback features. Still further, existing systems generally are limited in their use, for example to either managing attendance or managing account information.

In addition to the above difficulties, increasingly compliance with state and/or local regulations can be important to a school district or institution. For example, a school district may be hesitant about communicating student data to a remote computing system outside of the district due to data privacy regulations. In addition, the school district may wish to provide some specific information on demand to its employees (e.g., medical data for emergency response relating to students); however, this information may be sensitive, and therefore providing printed materials to the employee may be unadvisable, especially in circumstances where those materials may become accessible by students or other unauthorized individuals.

Accordingly, for these and other reasons, improvements in the general area of student data management are desirable.

### SUMMARY

In accordance with the following disclosure, the above and other issues are addressed by the following:

In a first aspect, a modular participant data management system includes a student database and a portal interface to the student database. The participant database is accessible by any of a plurality of users, each of the plurality of users associated with at least one organization. The participant database includes participant data and event data, the participant data associating each of a plurality of students with a unique code and a participant account associated with that unique code, the student account including contact information, medical information, and funds information. The portal interface provides access by authorized users to one or more participant data management modules. The participant data management modules include a transit tracking module, a participant account module, and a medical data module. The transit tracking module is accessible by school administration and transit personnel, the transit tracking module configured to receive a participant identifier from a remote computing system aboard a participant transit vehicle upon the participant boarding or exiting the participant transit vehicle. The transit tracking module is configured to store transit tracking events in the event data of the participant database and to generate one or more communications associated with the transit tracking events to participant guardians, the transit tracking events including a message from a driver indicating a status of the participant transit vehicle and an automated notification indicating entry or exit of the participant. The participant account module is configured to provide, based on the unique code, access to funds deposited in a participant account by a participant in association with preauthorized expenses incurred by the participant with the organization. The medical data module is accessible by preauthorized organization personnel and provides access to and instructions regarding emergency medical information associated with a participant based on the unique code associated with the participant.

In a second aspect, a method of managing student data is disclosed. The method includes assigning a student identifier to each of a plurality of students in a school, the student identifier unique to each student. The method includes issuing each of the students an ID card embodying that student's associated student identifier, and capturing an image of the student identifier when presented by the student. The method also includes performing one or more actions based on the student identifier and data in a student database. The actions are selected from a group of actions comprising: registering the student's entry or exit from a student transit vehicle and automatically generating a notification sent to that student's guardian; accessing a medical record associated with the student, the medical record including an option to initiate two-way communication with a parent or EMS personnel; providing access to a student event to the student and automatically generating a notification sent to that student's guardian; allowing a student to perform a transaction adding or subtracting value from a student account, and creating a log accessible by the student's guardian recording the transaction.

In further aspects, methods of use and operation of the modular participant data management system are provided.

### BRIEF DESCRIPTION OF THE DRAWINGS

FIG. 1 illustrates a network in which the modular student data management system can be implemented;

FIG. 2 illustrates example contents of a student database, according to an example embodiment;

FIG. 3 is a diagram illustrating various modules of an example portal interface of a modular student data management system;

FIG. 4 is a block diagram of an example electronic computing device with which aspects of the present disclosure can be implemented;

FIG. 5 illustrates operation of an example transit tracking module of the portal interface of FIG. 3;

FIG. 6 is an example user interface illustrating transit tracking status accessible via the portal interface;

FIGS. 7A-7C illustrate an example medical record accessible by authorized personnel via the portal interface

FIG. 8 illustrates an example communication interface incorporated into the transit tracking module;

FIG. 9 illustrates an example transit tracking log associated with a particular student;

FIG. 10 illustrates operation of a medical data module within the portal interface;

FIG. 11 illustrates operation of a ticketing module integrated with the portal interface to issue a ticket to a student for entry into an event;

FIGS. 12-13 illustrate operation of the ticketing module of FIG. 11 to provide concessions at the event which the student entered;

FIG. 14-15 illustrates access and use of a student account module integrated with the portal interface;

FIGS. 16A-16B illustrate student account activity logging and reporting based on student usage of the student account module;

FIG. 17 illustrates an example dashboard with which school personnel can view performance metrics associated with the modular student data management system;

FIG. 18A illustrates an example user interface displaying an analytics report for store assets;

FIG. 18B illustrates a sales report for an online school store linked via the modular student data management system;

FIG. 18C illustrates an example student transit log from the perspective of a school; and

FIG. 18D illustrates an example audit report able to be generated from the modular student data management system by a school administrator.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to a participant account information and tracking system. The present disclosure provides an integrated, modular system managed from a secure, centralized location from which participant data can be quickly accessed and managed. In accordance with the following disclosure, automatic updates can be provided to participant guardians regarding participant accounts and attendance, while specific participant data can be made accessible to different organization personnel or others interacting with the participants on an as-needed basis. Additionally, when needed a two-way conversation among users of the system can be instantiated, for example in cases where a participant has a medical issue, or where an issue can otherwise quickly be resolved through consultation with a guardian.

In various embodiments of the present disclosure, the participants can be, for example students affiliated with a school or school district. However, in alternative embodiments, participants can correspond to other individuals, such as children at a day care organization, or special needs individuals at a particular institution. Other participants could be encompassed within the meaning of the term, and within the scope of the present application, as well.

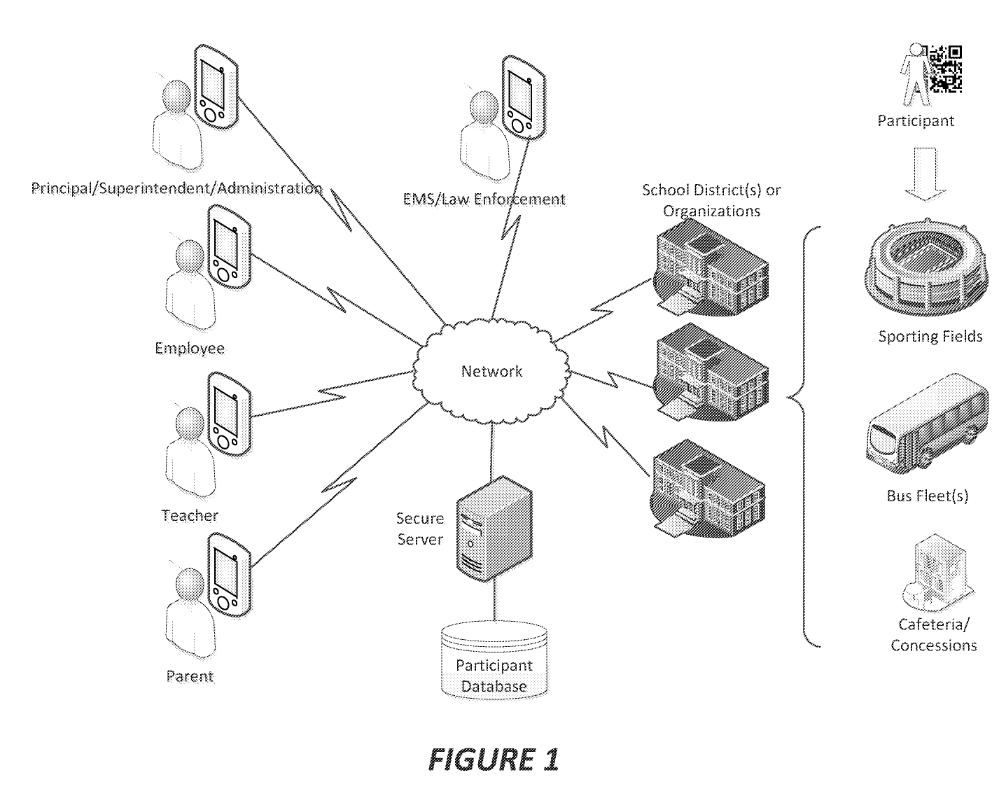

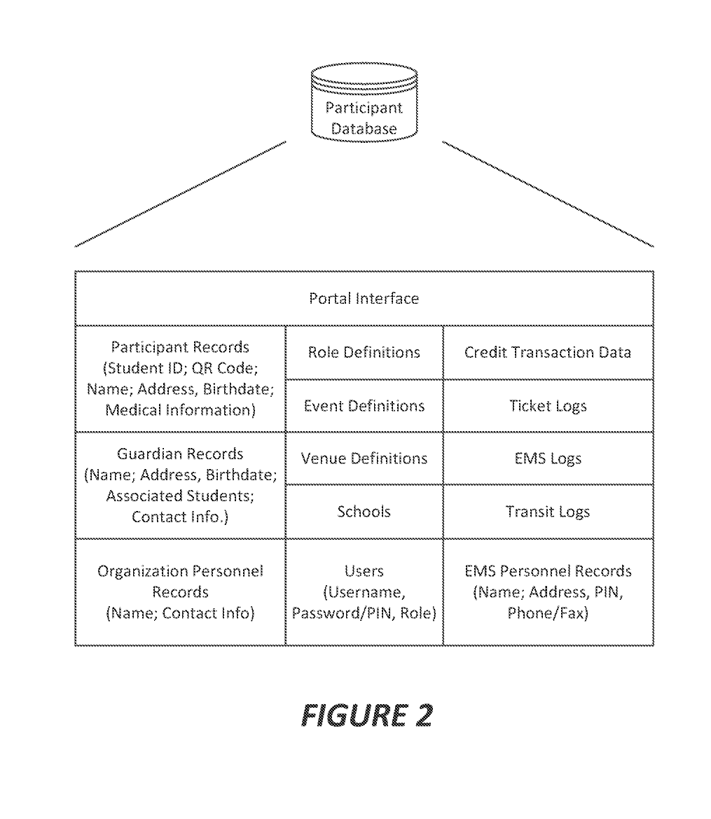

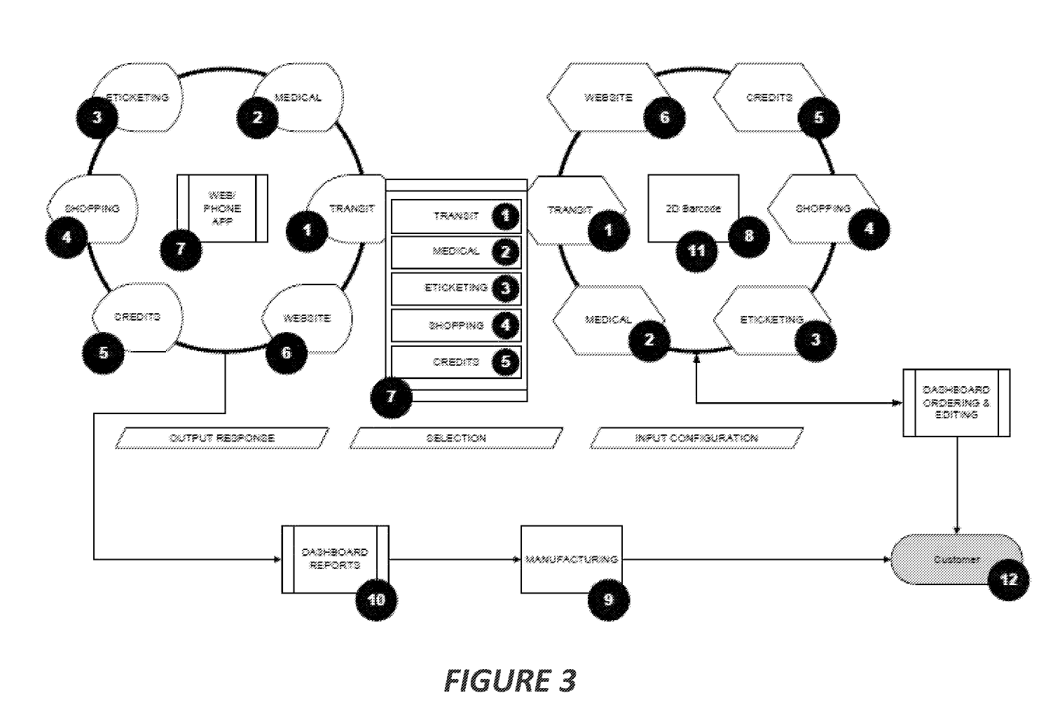

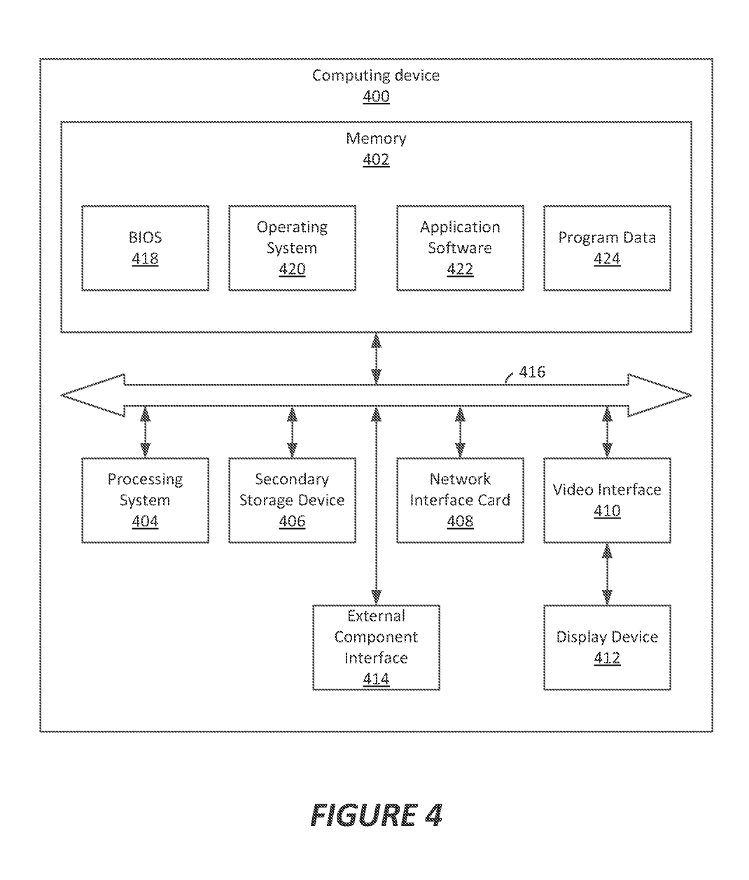

Referring now to FIG. 1, a network is shown in which the modular participant data management system can be implemented. The network includes a secure data storage location communicatively connected to and accessible by a plurality of organizations, such as schools and/or school districts. The secure data storage location also can be, in some embodiments, accessible to or communicate with individuals external to such schools or school districts, such as parents of students, or other authorized users, as will be further outlined below. The secure data storage location can include one or more computing systems such as are illustrated in FIG. 4 below, and which operate to host a participant database and portal interface to that participant database. Details regarding the participant database and portal interface are provided in FIGS. 2 and 3, respectively.

In general, a variety of users can access data at the server, and from the participant database (via the portal). These users can include a principal or superintendent associated with a school or district, a school employee (e.g., a nurse, security, administration), a teacher, or a parent/guardian of a particular student. In addition, the system can be configured to communicate with emergency medical staff or law enforcement otherwise unaffiliated with (but in the same geographical area as) the school or school district, in case medical or law enforcement needs arise at a particular school or organization.

In accordance with the present disclosure, each participant (e.g., student) can be associated with a particular code. The code can be a bar code, QR code (or other two-dimensional graphical code), an RFID tag, a magnetic stripe code, or some combination thereof. The participant can use that code within the district with which he/she is affiliated, for example for accessing events, such as at sporting fields, or as a spending account at a cafeteria, concession area, or school store. In addition, the code can be used to track a student's use of school transportation (bus systems); in particular with small children, such systems can provide assurance to parents that the student is traveling to and from school safely. In some embodiments, the code can be used for attendance purposes as well.

It is noted that in the arrangement shown in FIG. 1, a server is configured to support multiple school districts. In this case, the server and associated student database are typically cryptographically secured, to ensure that sensitive student data (e.g., medical records or other sensitive data) are not improperly shared, while still allowing those authorized users (e.g., teachers, superintendents) to view that information as needed, or in case of emergency.

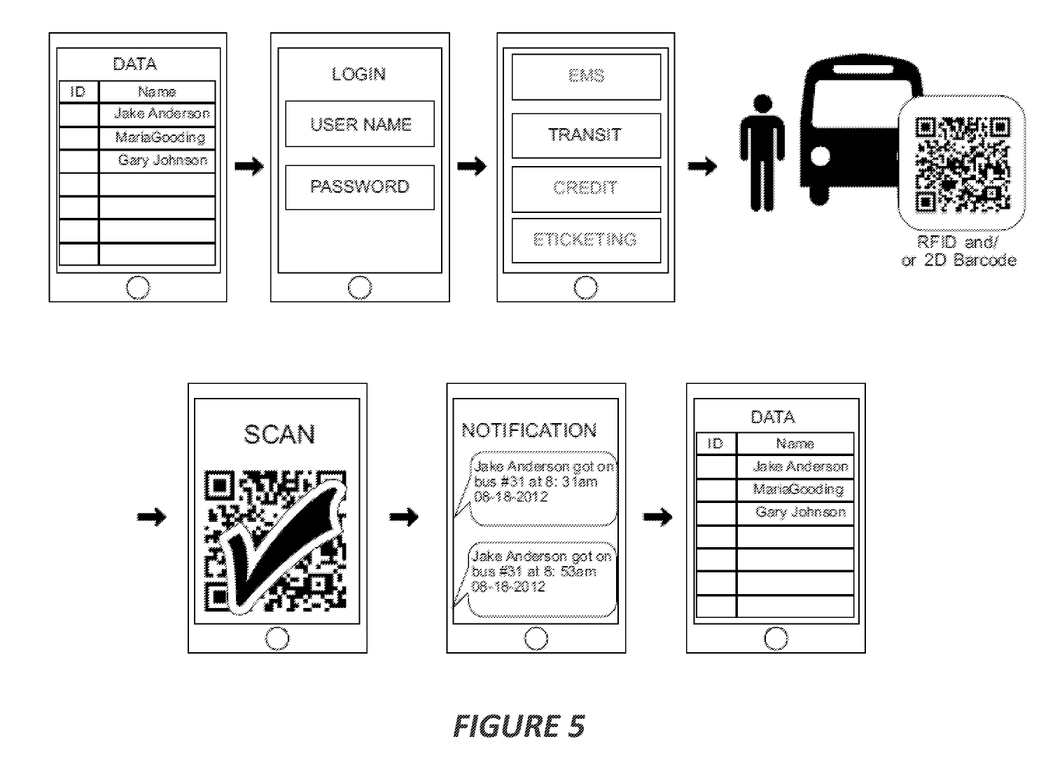

FIG. 2 illustrates example contents of a participant database, according to an example embodiment of the present system. In this embodiment, a portal interface provides an interface to underlying data captured regarding a plurality of school districts, associated schools, personnel at those schools, students, guardians, and other individuals affiliated or unaffiliated with the schools (in the case of EMS or law enforcement personnel). In addition, the portal interface provides a view into the student's accounts, and a method of accessing both information about the student and monetary credits attributed to the student, as needed. Specific details of an example portal design are illustrated in FIG. 3, and discussed further below in connection with FIGS. 5-16.

In the embodiment shown, the participant database stores student records, student guardian records, school personnel records, user records, and EMS personnel records. The student records store various name and contact information for a student, and also store a unique student identifier encoded onto a physical identification card issued to the student. As noted above, this code can be encrypted and embodied as a bar code or QR code, an RFID tag, a magnetic stripe code, or some combination thereof. The identification card can be a credit-card sized device, or any other type of object on which the identifier can be printed, such as a keychain, bracelet, sticker, or other object (referred to collectively herein as an ID card.

The guardian records can include name and contact information, as well as information about which one or more students are associated with that guardian. The school personnel can include name and contact information, as well as information about that person's role. EMS personnel records can include a name, address, role, and contact information. General user information can also include analogous information.

In addition the participant database stores a plurality of other definitions and logs. In the embodiment shown, the participant database stores role definitions, which define access rights of various classes of users. For example, a person authorized to access student data for purposes of selling that student a ticket to a game or a lunch would not typically be required to access that student's attendance or bus travel logs, or medical history; however, a student's guardian may be authorized to view that information. Concurrently, a superintendent would be able to access that type of information for all students within that superintendent's district, but not for students outside of his/her district and which are managed within the student database. The student database also stores event definitions, venue definitions, as well as definitions of schools and school districts. The event and venue definitions can be defined by the schools and districts with whom the events and venues are associated.

The logs included in the participant database can store a variety of types of information as well. For example, the logs can include credit information, defining credits associated with each student in a student spending account or other type of account. The ticket logs can include data regarding tickets purchased, redeemed, etc. regarding one or more events defined in the event definitions. EMS logs can include logs of instances where EMS personnel were called, or where medical record data was accessed. Additionally transit logs can provide a history of when each student boarded/exited a bus, or where other transit-related events may have occurred. In addition to the above, other types of logs, such as general audit logs that generate a record of each type of data access, can be captured as well, for data validation and security checking purposes.

FIG. 3 is a diagram illustrating various modules of an example portal interface of a modular participant data management system. The portal interface includes a plurality of modules that can be selectively added to a particular school's student data management plan, and can provide various different functionality associated with the data included in the participant database discussed above in connection with FIG. 2.

In the embodiment shown, the portal includes transit, medical, ticketing, shopping, and credits modules. In general, each of these items is tied to the encrypted code provided to each participant, and unique to that participant.

The transit module allows for verification of students boarding and exiting a participant transportation vehicle, such as a school bus. As discussed further in connection with FIGS. 5-9 below, a parent or guardian can receive an automated message each time a student boards or exits the vehicle. Additionally, the operator of that vehicle can communicate with specific individuals associated with the school or student, such as by sending a message or initiating a two-way conversation with a particular individual via the portal.

The medical data module allows for instant access to participant medical records, required treatments, emergency contacts, or any other information specific to the student. The medical data module includes a fast and easy way for personnel to update parent(s) (or any selected recipient) on student's condition, and ability for recipient to respond back, in a manner analogous to the transit module.

The ticketing module allows a student to use his/her code to obtain admission to sports, tournaments, fairs, festivals, concessions, and other school events. The shopping module allows the student to carry credits useable in school bookstores and for online purchases, reducing the need to carry cash, and reducing the risk of money disappearing from lockers. An associated credits module allows the student to carry value in their associated account for lunch programs, extracurricular activities, or any other programs within the school.

In some embodiments, the system overall also includes a website that allows students to scan his/her own ID code from a QR code to access a school's general purpose website, from which the student can access the portal with appropriate credentials (e.g., an intranet site accessible by students). In this way, unauthorized scans of the student's code would not allow for access to student data. In addition, the portal is accessible via a mobile application that provides an interface to the portal. The portal ensures security by use of specified logins, preventing unauthorized persons/strangers from getting important personal information associated with the students.

In addition to the above, some users may be capable of accessing data in the participant database via a dashboard. The dashboard allows students, parents, and school staff to login to see and edit orders, credits, personal information, and anything else they have access to. Furthermore, to the extent specific products may be purchased (e.g., from an online “school store”), a manufacturing component can provide on-demand printing and manufacturing for school-branded products. This can include, for example, RFID, online store orders, keychains, student IDs, and sporting gear.

Referring now to FIG. 4, a schematic illustration of an example computing system in which aspects of the present disclosure can be implemented. The computing system 400 can represent, for example, any of the computing systems or devices described herein, and can be implemented as a desktop, server, laptop, tablet, smartphone, or other mobile device system.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. However, such computer readable media, and in particular computer readable storage media, are generally implemented via systems that include at least some non-transitory storage of instructions and data that implements the subject matter disclosed herein.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

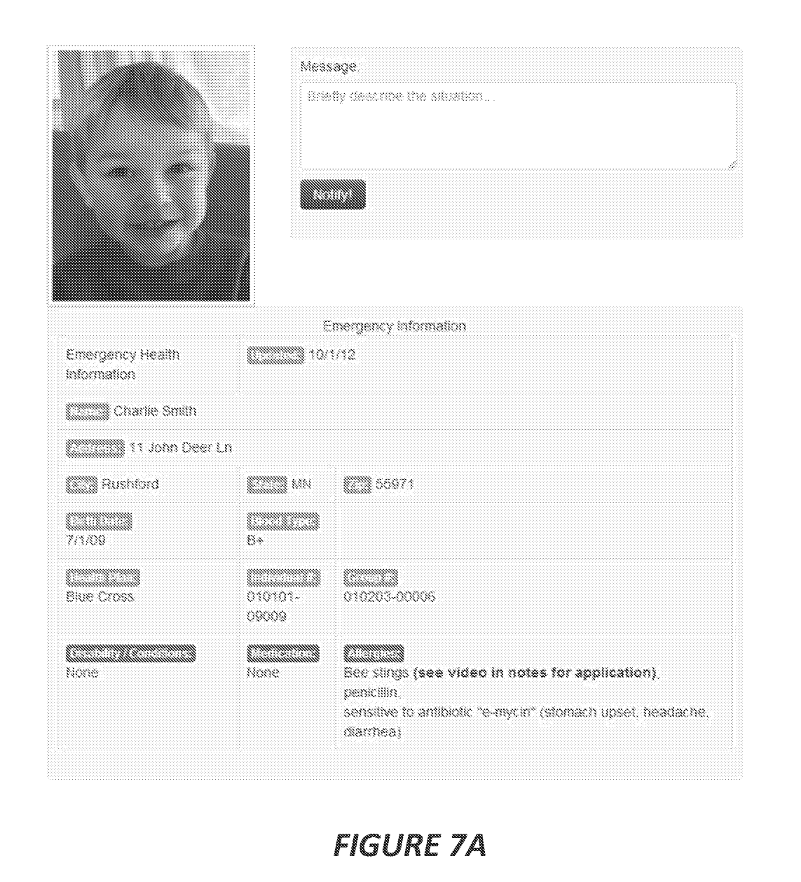

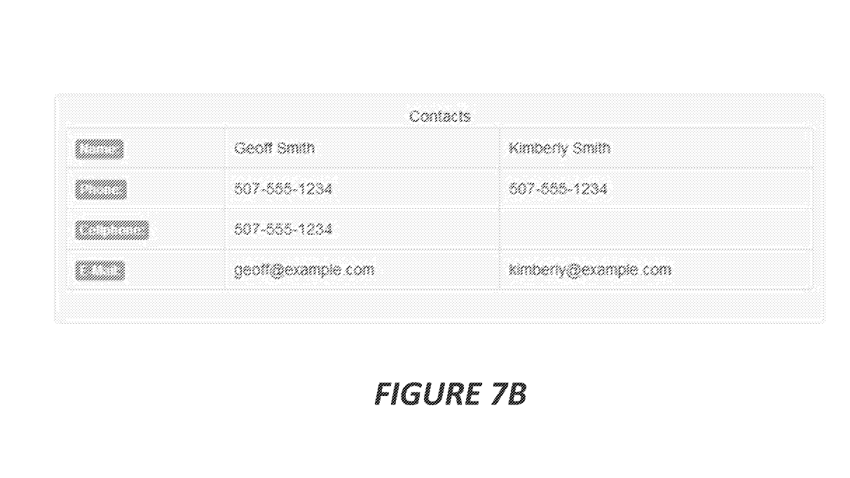

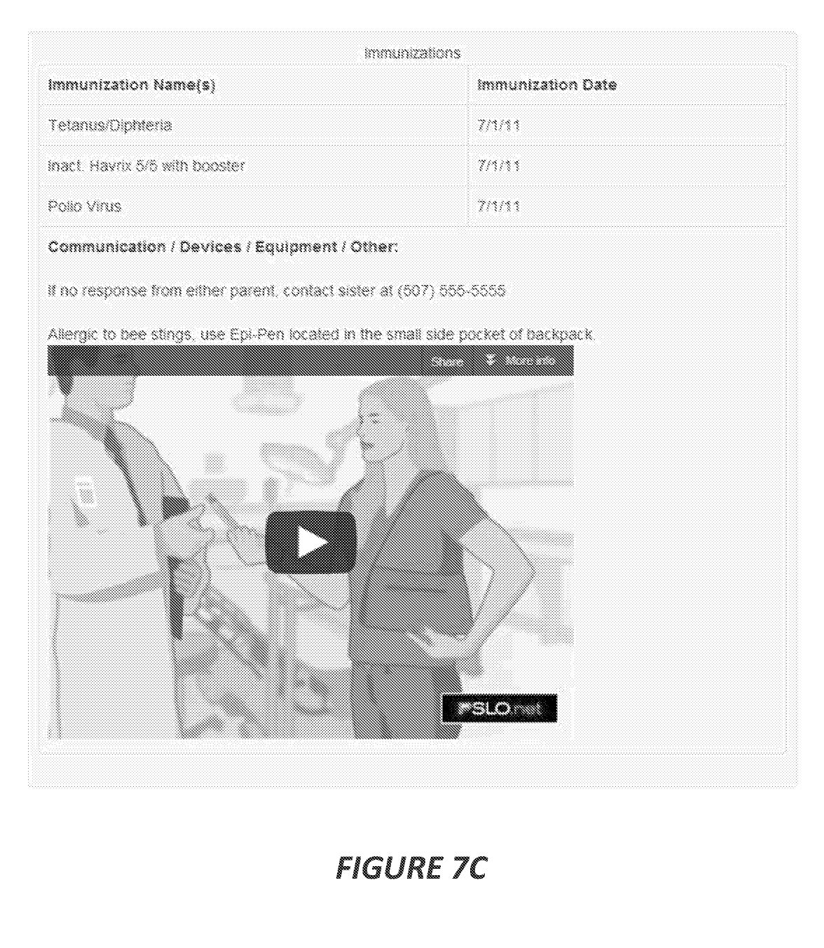

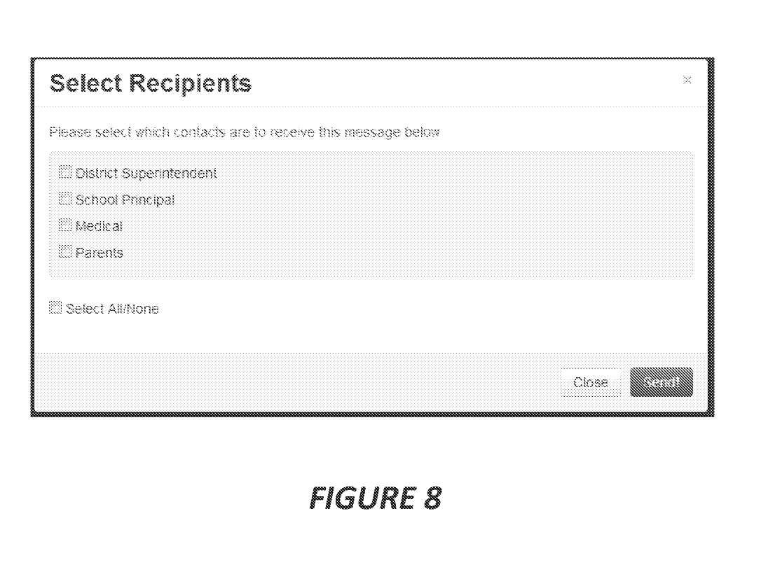

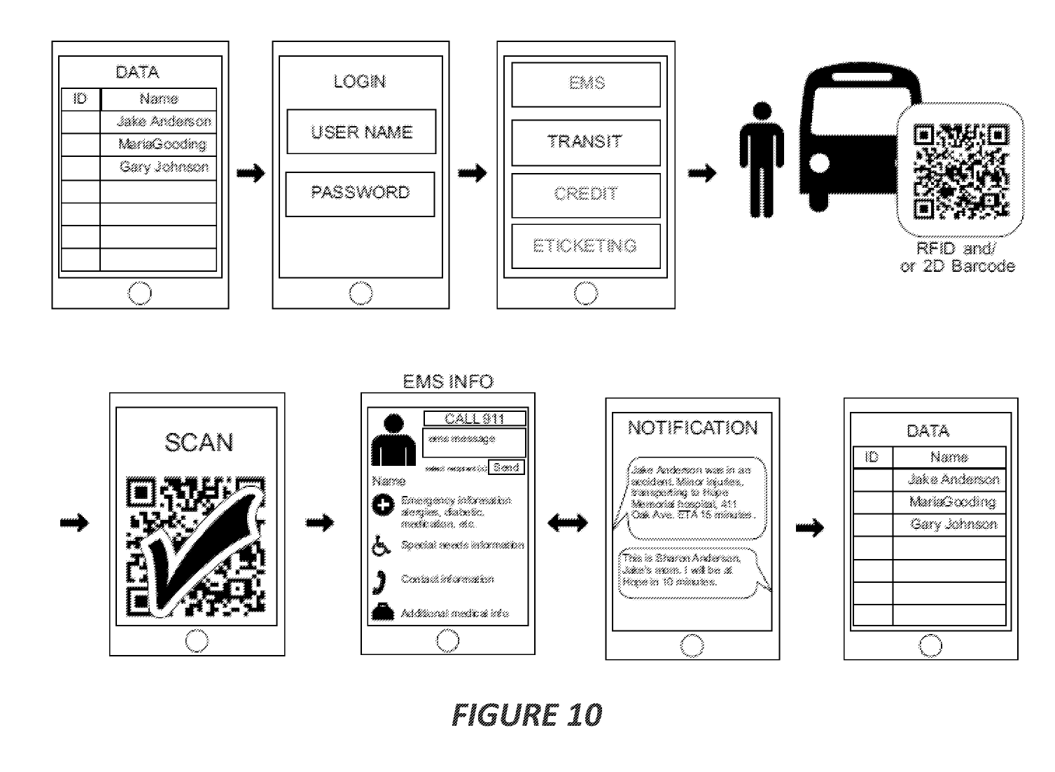

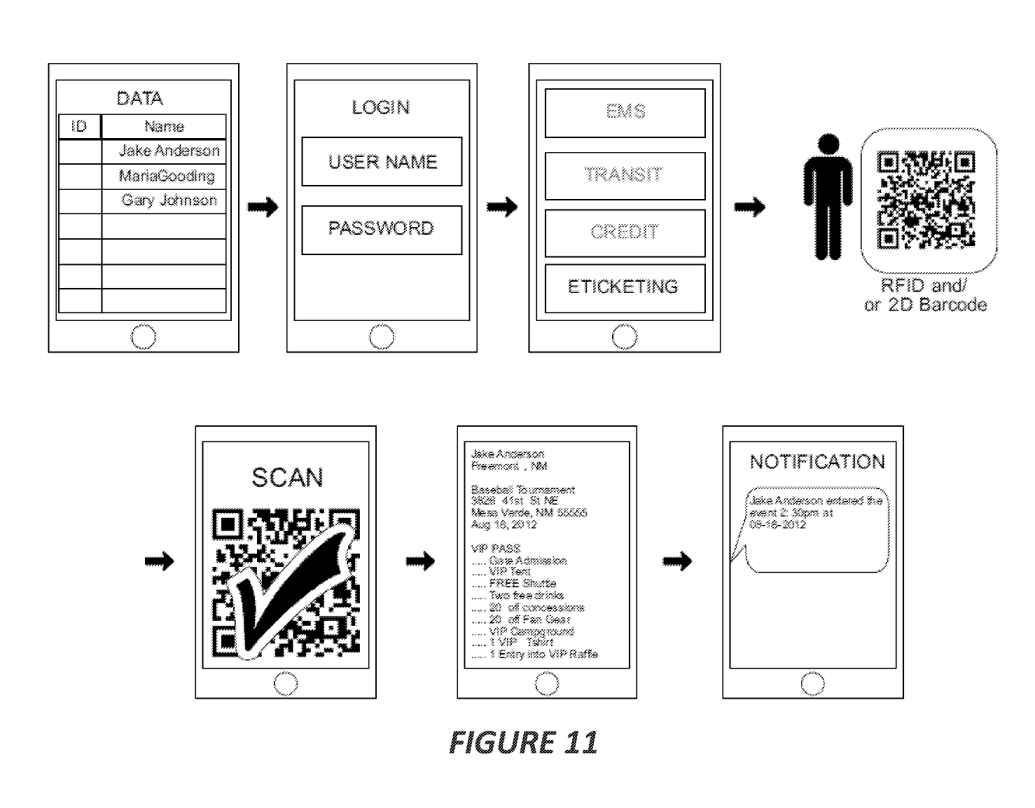

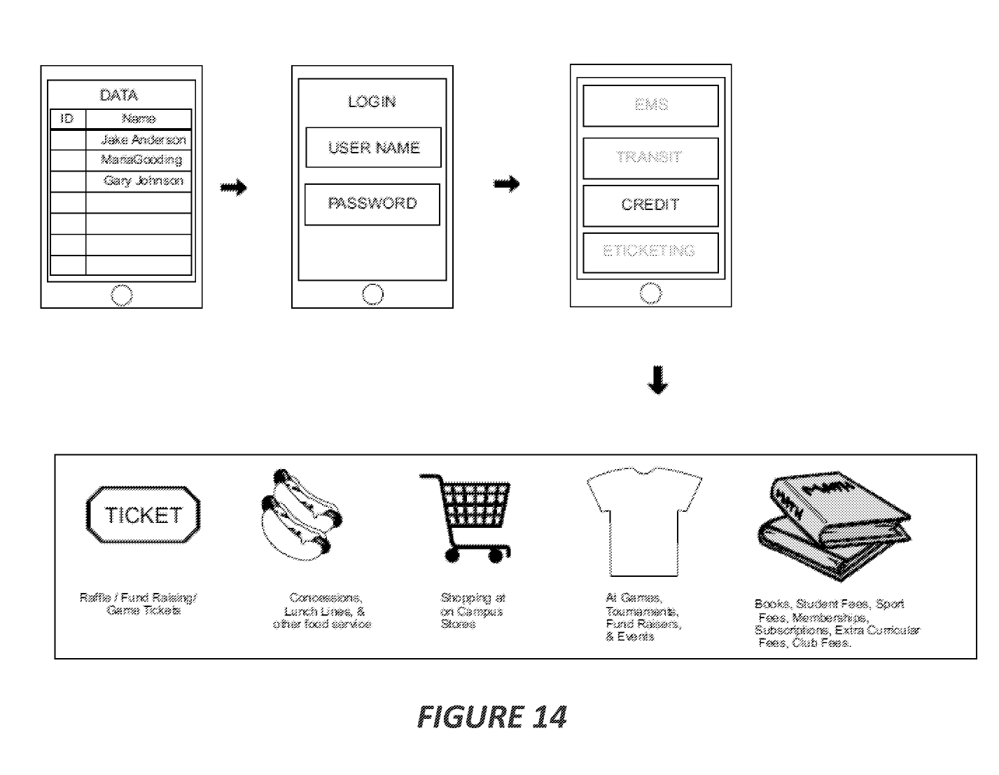

Referring now to FIGS. 5-16, additional details regarding the modules available via the portal interface of FIG. 3 are provided. In particular, FIGS. 5-9 illustrate operation of a transit tracking module of a portal interface. FIG. 10, and FIGS. 7-8, also illustrate operation of a medical data module. FIGS. 11-13 illustrate operation of a ticketing module, while FIGS. 14-16 illustrate operation of a participant account module.

Referring to FIGS. 5-9, the transit tracking module of the portal interface can be used to monitor a student's entry or exit from a participant transport vehicle, such as a school bus. In use, the school bus driver or other operator will have a portable device having a data connection and is communicatively connected to the portal. That operator is logged in to the portal as himself/herself, and selects the “transit” option in the portal. When a student enters the bus, his/her code is scanned, for example using a camera or other device associated with the portable device.

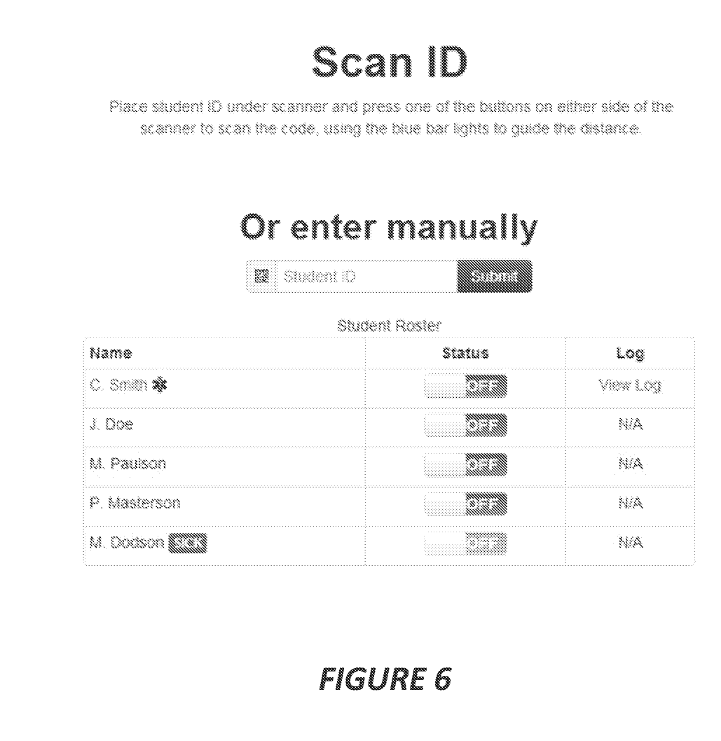

Upon registration of the scan, the scan is transported to the portal, which registers that the student has boarded or exited the bus. One or more automated notifications can then be generated and sent to a parent or guardian. In the example shown, a possible notification is shown indicating that a “Jake Anderson” boarded a particular bus at a specific time. This allows the parent or guardian, who may not be waiting for the bus with his/her student, to know that the student in fact successfully was transported to the school. As seen in FIG. 6, a portal dashboard visible to the driver can keep track of when the student is or is not boarded, and can maintain a roster of students who should be collected for transit to the school.

As illustrated in the example shown in FIG. 6, specific notifiers can be presented to the driver in case a student is sick (and therefore will not be picked up that day) or has particular medical conditions that the driver should be aware of. For those students with medical conditions, the driver can click on that individual's name and access a medical records screen (shown in FIGS. 7A-7C) to see specific issues that participant has. In the example shown, a particular student has a bee allergy; the medical record allows the driver to see where the student typically carries his/her medication (e.g. an epi-pen in the example shown), and provides a video illustrating proper administration of that treatment.

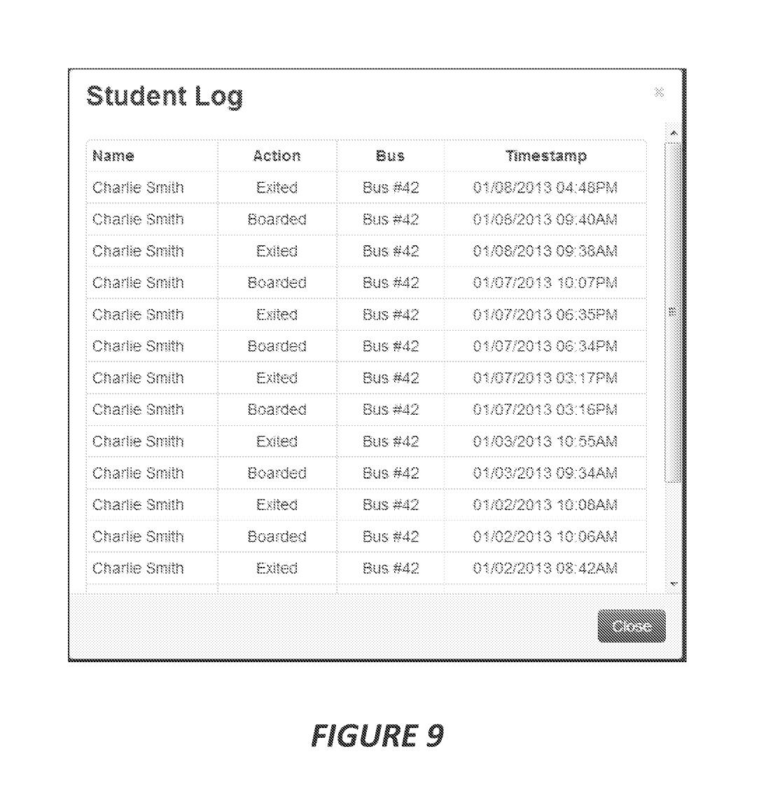

As illustrated in FIG. 8, an example screen in the portal useable to send a custom message is illustrated. The screen shown can be generated in response to selection of the “Notify” button in FIG. 7A, and allows the portal user (e.g., a driver) to notify school or medical personnel, or a parent, in the event of an issue with a particular student, whether behavioral or medical. FIG. 9 illustrates an example of a transit log associated with that student, for example as could be generated from the “View log” option illustrated in FIG. 6.

FIG. 10 illustrates operation of a medical data module within the portal interface. The medical data module requires school personnel to log in to the portal using his/her own credentials (a username and PIN number or other password), and selecting a “Transit” or “Medical” module in the portal. In the embodiment shown, these modules are merged in the “transit” option; however, in alternative embodiments, separate transit and medical options could be displayed on a portal home page. In this embodiment shown, the driver or school personnel could scan a student's code, and access EMS information. That EMS information can include a screen providing quick notification to nearby EMS personnel as well as the student's parents and optionally other school personnel, and can allow the user to enter a message regarding the issues experienced. A two-way communication arrangement can be then generated, allowing a parent to respond confirming that a message was received, allowing EMS personnel to provide instruction, or some other type of communication between the user of the system and the contacted individuals.

Although discussed in the context of a medical emergency occurring on a bus, it is understood that the medical data module could be instantiated by an employee at a school, in the event that EMS personnel are required at the school and no other convenient communication mechanisms are available.

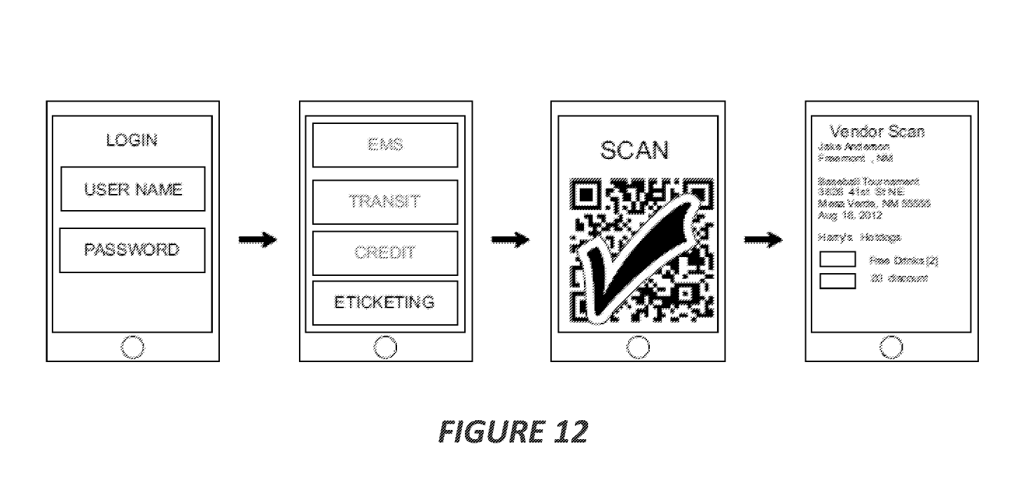

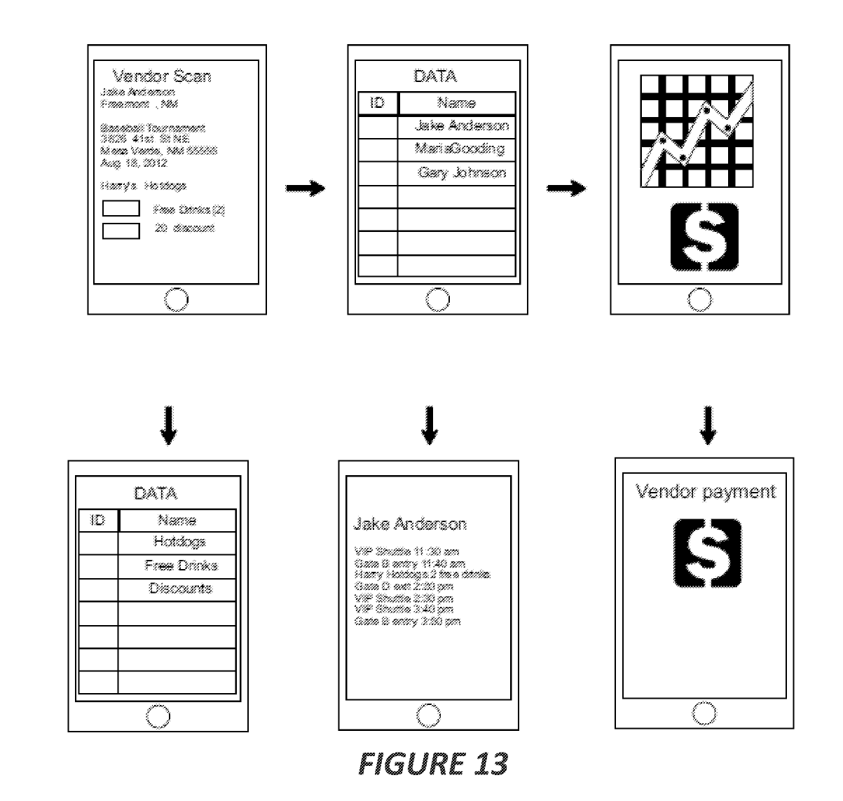

FIG. 11 illustrates operation of a ticketing module integrated with the portal interface to issue a ticket to a participant for entry into an event. In the embodiment of the ticketing module shown, a scan of a student's identification code will provide that user with access to a particular event. Additionally, a notification can automatically be generated and sent to that student's parent or guardian in a manner analogous to the transit tracking module, allowing the parent to know about his/her child's whereabouts. In addition, FIGS. 12-13 illustrate operation of the ticketing module of FIG. 11 to provide concessions at the event which the student entered. In FIG. 12, the student can have his/her code scanned again at a concessions stand to purchase items using monetary value associated with an account, or to receive discounts on items. In FIG. 13, that scan can result in logging of the items purchased, as well as to a vendor payment associated with the purchase.

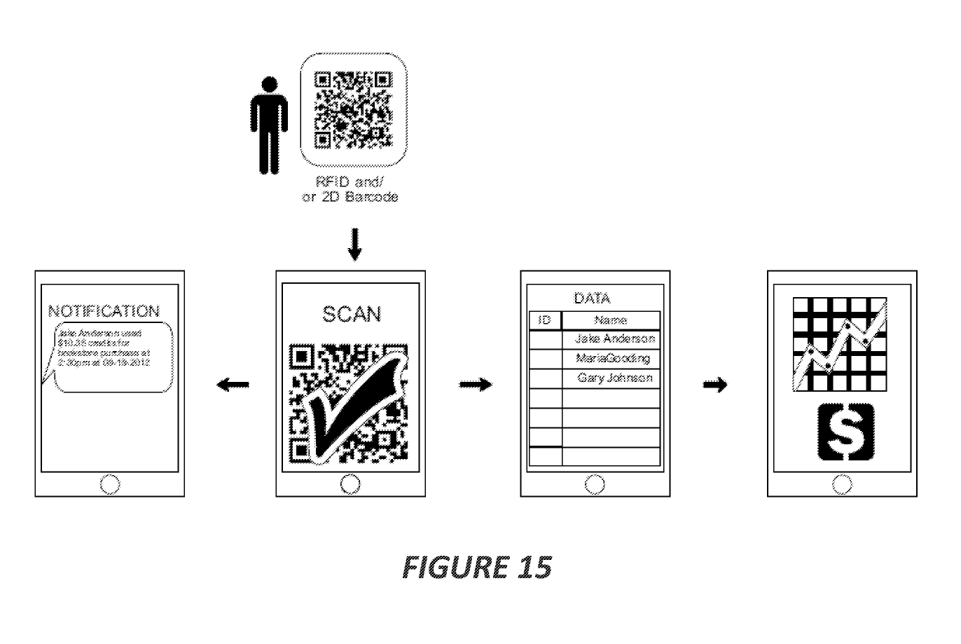

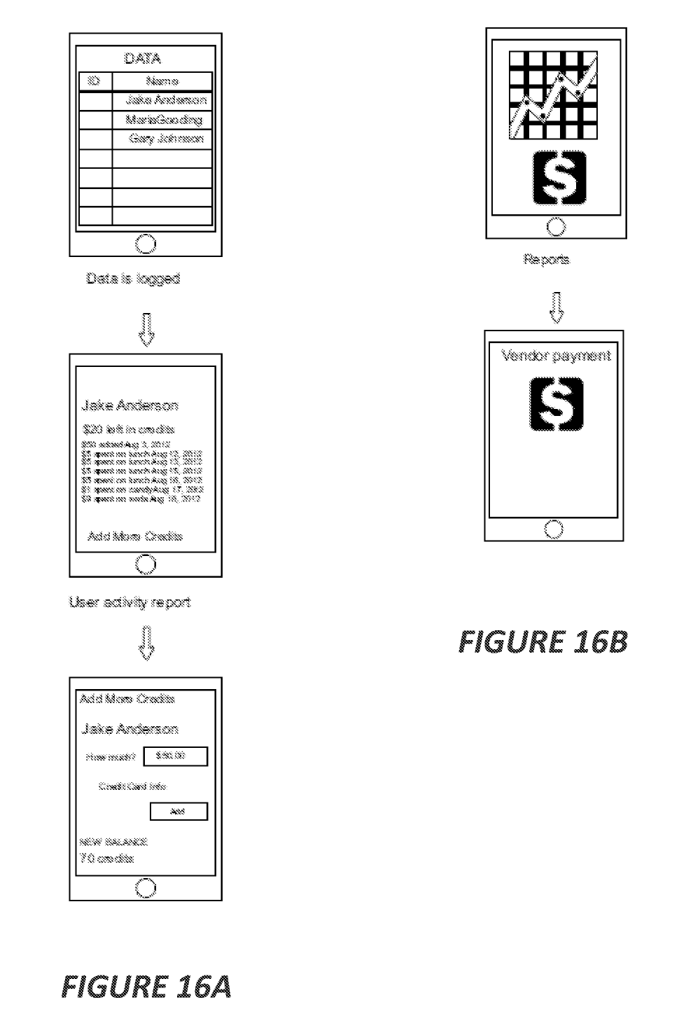

FIGS. 14-15 illustrate access and use of a participant account module integrated with the portal interface. The participant account module, or credit module, can be used by a student and his/her parent or guardian to add value to a student account that can be used for purchase of items, such as concessions, tickets, items at a school store, student fees, books, extracurricular fees, or other items. As illustrated in particular in FIG. 15, purchase of such items can result in generation of an automated notification to the student's parent or guardian providing notice of the items purchased, as well as registration of the purchase. Any such purchases can be logged, and the monetary value associated with the account can be adjusted accordingly. In connection with this system, rather than a purchase, a student can have his or her code scanned to have additional value added to his/her account or view a log of expenditures (see FIG. 16A). Additionally, other users, such as school administrators, can view reports of purchases, and effect vendor payments for such items that are purchased by students (FIG. 16B).

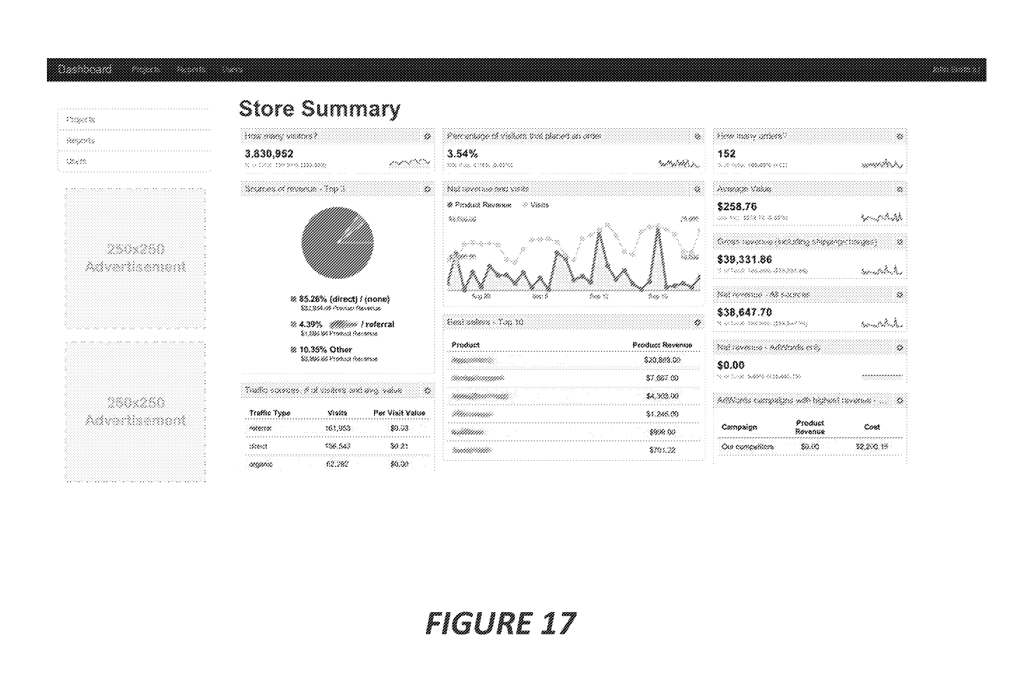

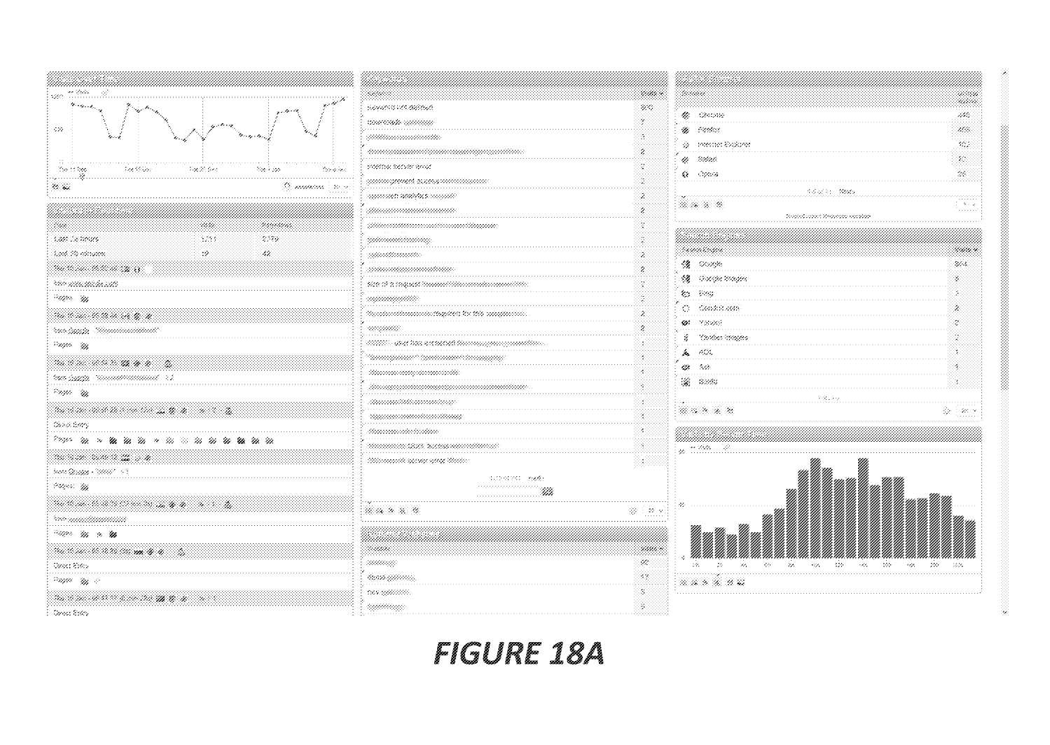

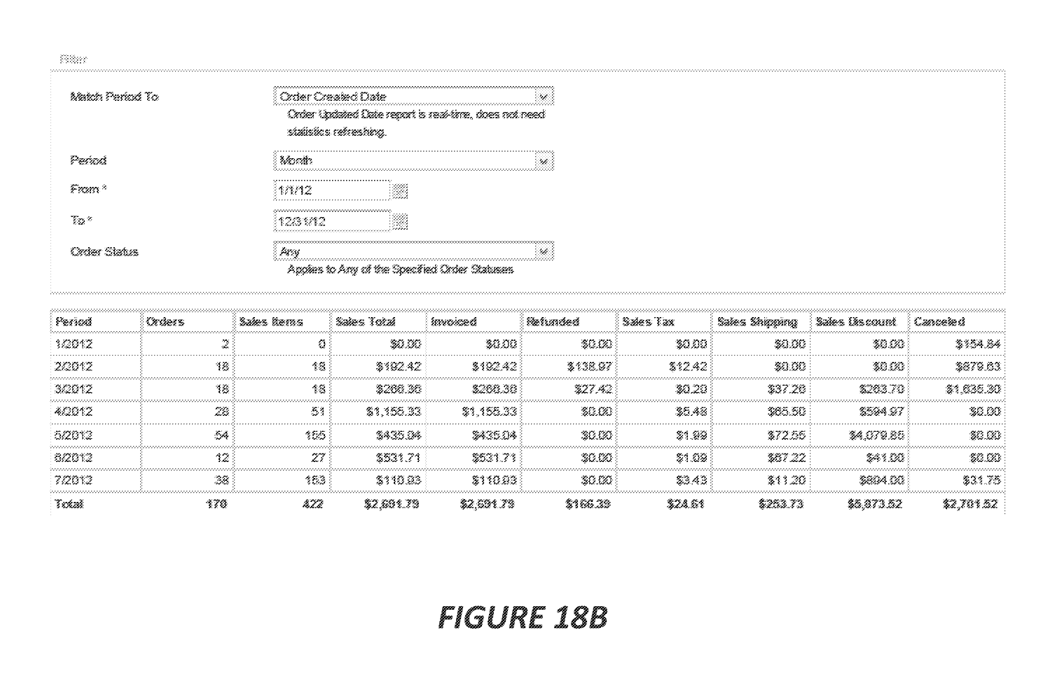

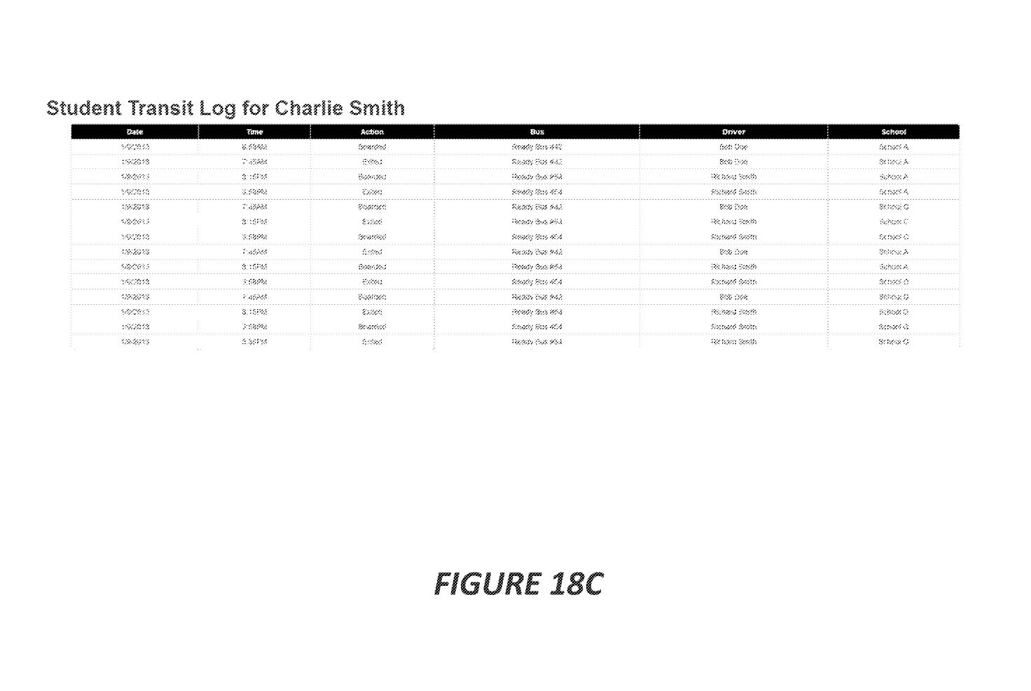

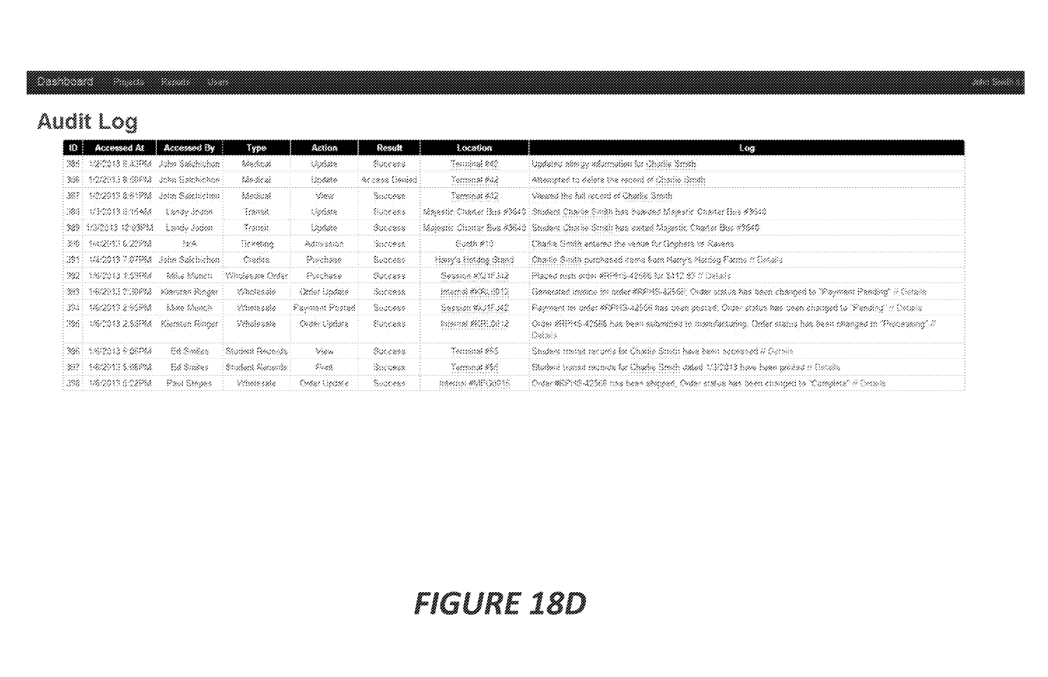

In connection with the present disclosure, some users can additionally view various reports using the portal interface. For example, as illustrated in FIG. 17 and FIGS. 18A-18D, various users, such as administrative personnel associated with a school or organization, can view summary reports of various aspects or modules within the overall system, or for the system as a whole. For example, FIG. 17 illustrates an example dashboard layout showing orders, visits, use, and a combination of such data. It is recognized that various other layouts and combinations of data could be presented on the dashboard, in various embodiments.

In addition to the dashboard of FIG. 17, FIGS. 18A-18D illustrate drill-down views into data on the dashboard. FIG. 18A illustrates an example user interface displaying an analytics report for store assets. FIG. 18B illustrates a sales report for an online school store linked via the modular student data management system. FIG. 18C illustrates an example student transit log from the perspective of a school. FIG. 18D illustrates an example audit report able to be generated from the modular student data management system by a school administrator. Other example drill-down reports can be generated as well.

Referring now to the disclosure overall, it is noted that the present system provide a variety of advantages over existing systems. In particular, the present system allows for different school districts to select certain subcomponents of an overall system for use in that particular school, without requiring that school to implement and host its own school accounts/attendance and student accounts system. Furthermore, the present system maintains student accounts and attendance separately from information which is even more restricted (e.g., grade or disciplinary information) which are typically not required to be known by users of a student account and tracking system. Furthermore, by using a publically-accessible portal interface with access controls integrated thereon, the present system thereby controls data access by users inside and outside of the school or district, and also supports two-way messaging to individuals both within and external to a school district. Other advantages are apparent as well from the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A modular participant data management system comprising:
a participant database accessible by any of a plurality of users, each of the plurality of users associated with at least one organization, the participant database including student data and event data, the student data associating each of a plurality of participants with a unique code and a participant account associated with that unique code, the participant account including contact information, medical information, and funds information;
a portal interface to the participant database, the portal interface providing access to authorized users of one or more participant data management modules, the participant data management modules including:
a transit tracking module accessible by school administration and transit personnel, the transit tracking module configured to receive a participant identifier from a remote computing system aboard a participant transit vehicle upon the participant boarding or exiting the student transit vehicle, the transit tracking module configured to store transit tracking events in the event data of the participant database and to generate one or more communications associated with the transit tracking events to participant guardians, the transit tracking events including a message from a driver indicating a status of the participant transit vehicle and an automated notification indicating entry or exit of the participant;
a participant account module configured to provide, based on the unique code, access to funds deposited in a participant account by a participant in association with preauthorized expenses incurred by the participant with the organization;
a medical data module accessible by preauthorized organization personnel, the medical data module providing access to and instructions regarding emergency medical information associated with a participant based on the unique code associated with the participant.

2. The modular participant data management system of claim 1, wherein the portal interface further includes a ticketing module configured to allow student access to school events based on the unique code associated with the participant.

3. The modular participant data management system of claim 1, wherein the unique code comprises a two-dimensional graphical code printed on an object issued to the participant.

4. The modular participant data management system of claim 3, wherein the object comprises an identification card.

5. The modular participant data management system of claim 1, wherein the participant comprises a student, and wherein the organization comprises a school district

6. A method of managing student data comprising:
assigning a student identifier to each of a plurality of students in a school, the student identifier unique to each student;
issuing each of the students an ID card embodying that student's associated student identifier;
capturing an image of the student identifier when presented by the student; and
performing one or more actions based on the student identifier and data stored in a student database, the actions selected from a group of actions comprising:
registering the student's entry or exit from a student transit vehicle and automatically generating a notification sent to that student's guardian;
accessing a medical record associated with the student, the medical record including an option to initiate two-way communication with a parent or EMS personnel;
providing access to a student event to the student and automatically generating a notification sent to that student's guardian; and
allowing a student to perform a transaction adding or subtracting value from a student account, and creating a log accessible by the student's guardian recording the transaction.
